(19) United States
(12) Patent Application Publication
(10) Pub. No.: US 2013/0117257 A1
(43) Pub. Date: May 9, 2013

(54) QUERY RESULT ESTIMATION

(71) Applicants: Henricus Johannes Maria Meijer, Mercer Island, WA (US); Michael Isard, San Francisco, CA (US); Alexander Sasha Stojanovic, Los Gatos, CA (US); Carl Carter-Schwendler, Redmond, WA (US); Stephen Harris Toub, Seattle, WA (US)

(72) Inventors: Henricus Johannes Maria Meijer, Mercer Island, WA (US); Michael Isard, San Francisco, CA (US); Alexander Sasha Stojanovic, Los Gatos, CA (US); Carl Carter-Schwendler, Redmond, WA (US); Stephen Harris Toub, Seattle, WA (US)

(73) Assignee: MICROSOFT CORPORATION, Redmond, WA (US)

(21) Appl. No.: 13/288,947

(22) Filed: Nov. 3, 2011

(51) Int. Cl. G06F 17/30

(52) U.S. Cl. 707/719; 707/E17.129

(57) ABSTRACT

Techniques for efficiently performing queries are provided. A search component can receive a request for information based on data, and a management component can determine a degree of accuracy requested for the information. In turn, the search component can render the information based on the degree of accuracy requested. In an aspect, the search generates a query configured to determine the first information, and the management component instructs the search component to perform the query to a level of completion less than full completion when the degree of accuracy requested is below a predetermined threshold to cause the search component to render an estimation of the first information. In another aspect, a tracking component can track information associated with multiple query requests and an analysis determine and employ a related aspect of the tracked information to a new query request to determine an answer for a the new query request.

### TECHNICAL FIELD

The subject disclosure relates to generating answers to query inquires efficiently by way of providing estimated answers or stored answers, and related embodiments.

### BACKGROUND

There is a vast amount of data available today and data is now being collected and stored at a rate never seen before. Further, through the employment of various systems such as the Open Data Protocol (Odata), data is becoming freed from specific applications and formats. As a result, data is becoming freely accessible and growing.

Big data is a term applied to data sets whose size is beyond the ability of commonly used software tools to capture, manage, and process the data within a tolerable elapsed time. Big data sizes are a constantly moving target ranging from a few dozen terabytes to many petabytes of data in a single data set. For example, big data can include but is not limited to web logs; radio frequency identification (RFID), sensor networks, social networks, social data, internet text and documents, internet search indexing, call detail records. In another aspect, big data can included astronomy, atmospheric science, genomics, biogeochemical, biological, and other complex and/or interdisciplinary scientific research, military surveillance, medical records, photography archives, video archives, and large scale electronic commerce.

Search tools provide users with the ability to find information for items of interest from available data. For example, query services can allow a user to search for and find specific information available over a network from a plurality of data sources based on the user's request. However, in general, sizable data such big data requires exceptional technologies to efficiently process large quantities of data within tolerable elapsed times. In particular a complete or entirely accurate answer can require an exhaustive review of all of the data available. Such an exhaustive review of data cannot only be inefficient with respect to time but also cost and energy.

The above-described deficiencies of today's query systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with efficiently performing queries with respect to time, cost, and resources.

For instance, an embodiment includes receiving, by a computing device, a request for information based on data, generating a query configured to determine the information, performing the query to a first level of completion less than full completion, and determining a first estimation of the information based on the performing the first level of completion. In an aspect the query comprises a computation based on N number of related functions, where N is an integer, and wherein the performing the query to the first level of completion comprises determining an estimated output of a first function, and employing the estimated output of the first function in the computation. In addition, where N is an integer greater than one, the query can be performed to a second level of completion less than full completion, including determining an estimated output of a second function and employing the estimated output of the second function and the first function in the computation, and determining a second estimation of the information based on the performing the query to the second level of completion.

In another non-limiting embodiment, provided is a system, comprising a memory having computer executable components stored thereon, and a processor communicatively coupled to the memory, the processor configured to facilitate execution of the computer executable components, the computer executable components comprising: a search component configured to receive a request for first information based on data, and a management component configured to determine a degree of accuracy requested for the first information, and wherein the search component is further configured to render the first information based on the degree of accuracy requested. In an aspect, the search component is further configured to generate a query configured to determine the first information, wherein the management component is configured to instruct the search component to perform the query to a level of completion less than full completion when the degree of accuracy requested is below a predetermined threshold, and wherein the search component is configured to render an estimation of the first information. In yet another aspect, the search component is further configured to receive multiple requests for additional information based on the data, and to generate and perform queries to determine either the additional information or an estimation of the additional information. The system can further comprise a tracking component configured to track query information associated with the queries and an analysis component configured to determine a correlation between the request for the first information and the query information, and wherein the search component is configured to employ the query information to determine the first information or an estimation of the first information based on the degree of accuracy requested for the first information.

Further, provided is a computer-readable storage medium comprising computer-readable instructions that, in response to execution, cause a computing system to perform operations, comprising receiving a request for information based on data, generating a query configured to determine the information, performing the query to a first level of completion less than full completion, and determining a first estimation of the information based on the performing the first level of completion. In an aspect, the query can comprise of a computation based on N number of related functions, where N is an integer, and wherein the performing the query to the first level of completion comprises, determining an estimated output of a first function; and employing the estimated output of the first function in the computation. Other embodiments and various non-limiting examples, scenarios and implementations are described in more detail below.

### BRIEF DESCRIPTION OF THE DRAWINGS

One or more of the various embodiments set forth herein are further described with reference to the accompanying drawings in which:

FIG. 1 illustrates a block diagram of an exemplary non-limiting system that can facilitate generating estimated answers to query inquires;

FIG. 2 illustrates a block diagram of another exemplary non-limiting system that can facilitate generating estimated or stored answers to query inquires;

FIG. 3 illustrates an example implementation of the subject query service in accordance with an embodiment;

FIG. 4 illustrates a process for generating an estimated answer to a query request in accordance with an embodiment;

FIG. 5 illustrates another process for generating an estimated answer to a query request in accordance with an embodiment;

FIG. 6 illustrates another process for generating an estimated answer to a query request in accordance with an embodiment;

FIG. 7 illustrates another process for generating an estimated answer to a query request in accordance with an embodiment;

FIG. 8 illustrates a process for rendering an answer to a query request in accordance with a degree of accuracy requested for the answer.

FIG. 9 is a block diagram representing an exemplary non-limiting networked environment in which the various embodiments may be implemented; and

FIG. 10 is a block diagram representing an exemplary non-limiting computing system or operating environment in which the various embodiments may be implemented.

### DETAILED DESCRIPTION

### Overview

By way of introduction, the subject matter disclosed herein relates to various embodiments relating to rendering efficient queries. In a first aspect, query methods or presented which facilitate rending estimated answers to query requests as opposed to an actual answers. In order to render estimated answers a query can be generated in response to a request a query and performed to a level of completion less than full completion. Levels of completion less than full completion sacrifice accuracy in order to achieve efficiency.

For example, a level of completion less than full completion can relate to performance or parts of a query, such as one or more functions less than all of the functions included in a query computation. In another aspect, a level of completion less than full completion can relate to the use of estimated values as outputs and/or inputs to functions associated with a query. According to this aspect rather than collecting a comprehensive of a population of data to employ as in input of a function, a representative sample can be taken and employed.

In addition, a query can be dynamically performed until a desired confidence level associated with an estimated answer is reached. In an aspect, the query can be carried out to multiple levels of completion based on control protocols. Each level of completion can increase the completion of a query computation toward full completion. A control protocol can control the performance of a query based on at least one of: a cost associated with performing a query, a resource constraint associated with performing a query, a duration of time associated with performing a query, a degree of accuracy associated with an estimated answer to a query, a confidence level associated with determining an estimated answer to a query, or a speed associated with determining an estimated answer to a query.

In another aspect, a query service can track information associated with query requests and performance of queries. For example, the query service can track key terms employed that prompt a query, functions employed in a query computation, data inputs and outputs associated with the functions, and control protocols associated with a query. The query service can further analyze current query requests to determine correlations between a current request and one or more past requests. If the query service observes a correlation, the query service can employ one or more aspects of the one or more previous requests against the current request. For example, if the query service determines a query request is the same or similar to a past request, the query service can provide a user with the answer to the past request without performing a new query computation. In another example, if the query service determines a query request is the same or similar to a past request, the query service can employ previously determined inputs for related functions employed in the past request, apply previous ordering schemes for performing functions employed in a past request, or apply control protocols employed against a query computation of the past request.

### Query Result Estimation

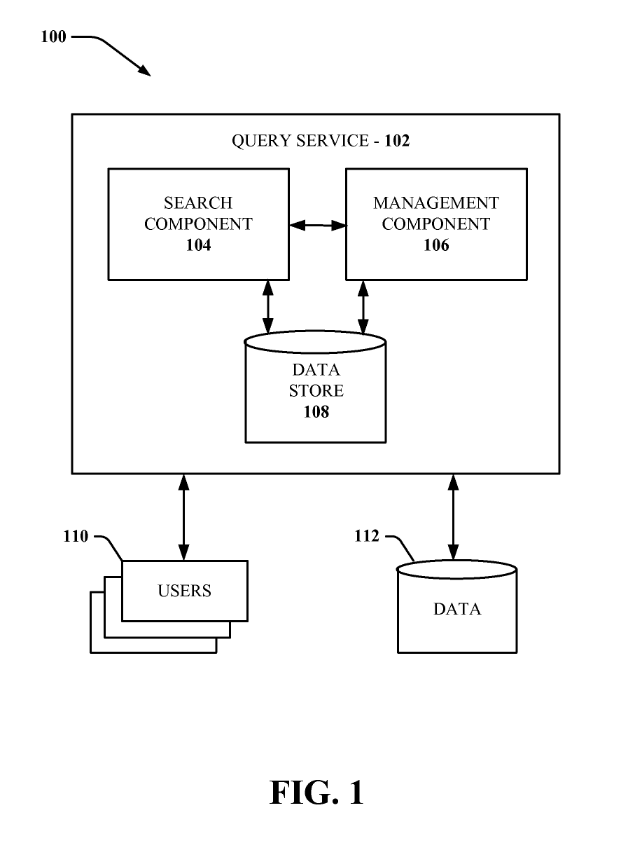

Referring now to the drawings, with reference initially to FIG. 1, a system 100 than can facilitate rendering an estimation of a query result is presented. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory (not depicted) for storing computer executable components and instructions. A processor (not depicted) can facilitate operation of the computer executable components and instructions by the system 100.

In an embodiment, system 100 includes a query service 102, users 110 and data 112. Query service 102 is configured to receive a request from a user 110 for information and issue a query against data 112 to determine the information. As used herein, the term user refers to a person, entity, or system that uses query service 102. In particular, a user 110 can be a person, entity, or system that issues a request for information from query service 102. For example, the user 110 can request an answer to a question, or a list of related possible items of interest based on key terms. In general, a user 110 is associated with a computing device. For example, a user 110 can employ a computing device to request information from query service 102.

Data 112, can include any possible type and source of data that can be employed by query service to facilitate determining requested information. In an aspect, data 112 is accessible via a network. There are many possible sources of data. For example, applications collect and maintain information in databases, organizations store data in the cloud, individual produce personal data and store it locally, and many firms make a business out of selling data. In an aspect, a data source includes one or more databases storing data 112. The data can be related or unrelated. In an aspect, the data 112 is considered big data. Big data is a term applied to data sets whose size is beyond the ability of commonly used software tools to capture, manage, and process the data within a tolerable elapsed time. Big data sizes are a constantly moving target ranging from a few dozen terabytes to many petabytes of data in a single data set. For example, big data can include but is not limited to web logs; radio frequency identification (RFID), sensor networks, social networks, social data, internet text and documents, internet search indexing, call detail records. In another aspect, big data can included astronomy, atmospheric science, genomics, biogeochemical, biological, and other complex and/or interdisciplinary scientific research, military surveillance, medical records, photography archives, video archives, and large scale electronic commerce. In general, big data requires exceptional technologies to efficiently process large quantities of data within tolerable elapsed times.

In an embodiment, query service 102 is configured to receive a request from a user 110 for information and issue a query against data 112 to determine the information. In an aspect, query service 102 is configured to determine an estimation of the requested information as an alternative to providing the actual information. As noted supra, often times an estimation of the requested information is desired over the actual information. For example, in general, a query involves a search process against data to determine a subset of the data. Further, queries can involve a variety of computations against the data to produce the subset. Depending on the type of the information requested, the amount of data available, and the organization of the data available, the more extensive and complex the query will be. As a result, the query process can be costly and time consuming.

Therefore, in an embodiment, query service 102 is configured to minimize time, cost and energy requirements associated with queries by providing an estimated answer to query request. In an aspect, in order to reduce time, cost, energy, query service is configured to perform a portion of a search query. In particular, rather than performing a search query to full completion to obtain a result, query service 102 cuts corners during the query process to produce an estimated result. As used herein, an estimated result is a result to a search query that is a calculated approximation of the real result. In an aspect, an estimated result is based on incomplete or uncertain information.

Referring back to FIG. 1, in order to facilitate performing queries, query service 102 can include search component 104, management component 106, and data store 108. In general, search component 104 is configured to receive a request for information from a user 110, generate a query based on the request, perform the query, and render the information in response to query. In an aspect, search component 104 is configured to perform the query to a level of completion less than full completion in order to render an estimation of the information. Management component 106 is configured to manage the generation and performance of queries by search component. Data store 108 is configured to store information employed by management component 106 to facilitate the generation and performance of queries by search component 104.

As noted supra, in an embodiment, search component 104 is configured to receive a request for information from a user 110. In an aspect, a request can include a question. In another aspect, a request can include a command. The question or command can be simple or complex, broad or narrow, and invoke a wide range of results. For example, a user can request a list of data sources that conform to parameters x, y, and z. In another example a user could ask a question such as “What is Coco Poff's favorite restaurant in Cleveland?” A user can request information in a variety of forms. For example, a user can provide the search component 104 with one or more key terms. In another example the user can provide the search component 104 with one or more operators. In another example the user can employ a form comprising check boxes databound to one or more fields.

Regardless of the form of a request, in an aspect, in response to a request, search component is configured to generate a query based on the request. For example, in order to request information, the user can provide the search component 104 with data, and based on the provided data, the search component 104 is configured to generate a query. In particular, the search component 104 is configured to recognize the data provided by the user for a request and formulate query. In an aspect, the search component 104 is configured to recognize search terms, operators, and the organization of search terms and operators. In another aspect, in order to generate a search query, search component 104 can employed pre-configured rules associated with search terms, operators, and the organization of search terms and operators. Such pre-configured rules can be stored in data store 108. For example, a rule could include “employ a find and sort function” against the data when the request includes text data. It should be appreciated that a variety of data processing associated with the generation of search queries can be employed by search component 104. In particular, search component 104 is configured to employ any type of programming parameters outlining formulation of queries in response to requests for information. In aspect, search component 104 is configured to generate queries that efficiently and effectively produce the desired information. In an aspect discussed infra, search component 104, search component is configured to employ information associated with previous search queries to generate search queries for a current request for information.

In an embodiment, a query can comprise of a computation based on N number of related functions, where N is an integer. According to this embodiment, a query can comprise of a single function or part. For example, the function could be a find function. According to this example, search component 104 could receive a key term such as “Britney Spears.” As a result, the search component 104 could generate a query configured to calculate a find function defined as “find all data sources that include the term “Britney Spears.” In another aspect, a query can comprise of multiple functions or parts. For example, a search request for information could generate a query that is a sum of several parts associated with data 112. In another aspect, a query can comprise multiple related functions associated with data 112. For instance, a query can comprise of a function defined as Y=h(g(f(x)) where Y is the value or output of the function and represents the information requested. It should be appreciated that the above example comprising of a three part function is merely presented to demonstrate the concept that a query can comprise of multiple related functions. The number of functions and the manner in which they are related can vary. In an aspect, a query can comprise of multiple functions related based on algebraic properties. For example, the functions can be commutative, associative, distributive, additive, or multiplicative.

In an aspect, a query comprises one or more parts or functions that employ data 112. In particular, a query can be configured to compute an answer based on data 112. For example, the query can require parsing a data store to find a subset of data 112. In an aspect, the query can determine a subset of the data and employ the subset of the data as input of at least one of the functions.

As noted supra, in order to facilitate estimated results to queries, search component 104 is configured to perform a query to a level of completion less than full completion. In an aspect, search component is configured to perform a portion of a query. As used herein, performance of a “portion” of a query indicates performance of less than a full query. In other words performance of a portion of a query means the non-completion of a generated query. Therefore in an aspect, performance of a portion of a query means performance of a query to a certain level of completion less than full completion. In an aspect, a query can comprise of multiple portions where performance of each portion and/or combinations of portions is associated with a level of completion. For example, performance of a first portion can indicate a certain level of completion while performance of a second portion can indicate another level of completion. In addition, performance of both a first portion and a second portion can indicate yet another level of completion. Further, each level of completion can result in an output value of the query. The output value can represent an estimation of the requested information for which the query is based. Therefore, in an aspect, performance of a portion of a query and/or the level of completion of a query indirectly relates to a degree of accuracy of the estimation of the requested information.

In an embodiment, in order to perform a portion of a query, search component 104 can employ estimated values for the one or more parts of a query. For example, search component 104 is configured to estimate a value requested for performance of a query and perform the query with the estimated value. The result of the query may thus be “less than perfect” given the estimated value in the computation. In an example, a user may request information such as “the percentage of male children who visited the Dumbo ride in the past three hours.” Although the actual value may be 48 percent, the search component 104 can estimate the value to be 50 percent.

In another example, when a query involves a sum of multiple parts, search component 104 is configured to estimate a value for at least one of the parts and perform the query with the at least one estimated value. The result of the query may thus be “less than perfect” given the at least one estimated value in the computation. In furtherance to the above example, a user may request information such as “the percentage of male children who have road rides at Disney World in the last three hours.” In an aspect, the search component could formulate a query which includes finding the percentage of male children who road each of the individual rides at Disney World to find a cumulative average. According to this example, the search component can perform a portion of the query by finding an estimate for one or more of the individual rides prior to summation. It can be appreciated that the degree of accuracy of the query can vary depending on the number of estimated values employed in a query computation and the accuracy of the estimated values themselves. It can also be appreciated that the estimated values employed in a query computation may not affect the outcome of the query. For, example the weight of the estimated values with regard to an entire query computation may not be great enough to affect the result. In another example, the accuracy of the estimated values may be high enough to return the same result to a query if actual, non-estimated values were employed.

In another aspect, where a query includes a computation of one or more functions, performance of a portion of a query can involve an estimation of the output of at least one of the functions. For example, a query can require a subset of data from data 112 as input to at least one of the functions. According to this example, search component 104 can determine an estimation of the subset of the data 112 requested as the input for the at least one of the function and employ the estimate of the subset to get an estimate of the output of the at least one of the function. For example, in order to generate an estimate for a subset of the data 112 to employ as input to at least one of the functions, search component 104 can employ sampling to generate a sample of the subset from the data 112 representative of the subset. For example, search component can employ known or assumed statistics associated with data 112 to generate the subset. According to this aspect for example, the top 10% of a subset could be known and in turn selected. In an embodiment, search component 104 can employ probability sampling including: simple random sampling, systematic sampling, stratified sampling, probability proportional to size sampling, and cluster or multistage sampling. In another aspect, search component 104 can employ non-probability sampling. Non-probability sampling involves the selection of elements based on assumptions regarding the population of interest, which forms the criteria for selection. Hence, because the selection of elements is nonrandom, non-probability sampling does not allow the estimation of sampling errors. In yet another aspect, in order to perform estimation, search component can employ Gaussian distributions of points in the tables/data associated with data 112 when sampling.

In view of the above sampling aspects to estimate an output of a query function, it can be appreciated that the degree of accuracy of the information determined by a query can vary depending on the number of estimated outputs employed in a query computation and the accuracy of the estimated outputs themselves. It can also be appreciated that the estimated outputs employed in a query computation may not affect the outcome of the query.

In another aspect, where a query includes multiple parts or functions, performance of a portion of a query can involve performance of less than all of the functions or parts. For example, where a query involves two parts or functions, performance of only one of the parts or functions results in less than full completion of a query. It can be appreciated that a query can involve more than two functions. For example, a query could involve three functions, ten functions, or one hundred functions. In an aspect the more functions requested in a query, the less detrimental non-performance of one of the functions may be in the output of the functions. In another aspect, the various functions of a query may have different weighted impacts on the output of the query. According to this aspect, the effect non-performance of one of the functions will have on the output of the query can depend on the weight associated with the function.

Still in yet another aspect, where a query includes multiple parts or functions, performance of a portion of a query can involve both an estimation for at least one of the parts or functions and performance of less than all of the functions or parts. For example, a query could involve an estimation of three different subsets of data to employ as input for three out of ten functions and non-performance of one out of the ten functions.

Furthermore, as noted supra, in an aspect performance of a portion of a query represents performance of less than full completion of a query. According to this aspect performance of a portion of a query relates to a level of completion of a query. In an aspect, a level of completion of a query can comprise performance of one or more portions of a query. For example, performance of a first portion of a query can indicate a first level of completion while performance of a second portion of a query can indicate another level of completion. The levels of completion associated with the first portion and the second portion can be the same or different, depending on the weight attributed to each portion in comparison to the performance of the full query. According to this example, performance of a first portion of a query could include an estimation of a first input for a first function of a multi-function query and indicate a 25% level of completion or a “level 1” completion. Performance of the first portion of the query could result in an output of the query which represents estimation of the requested information.

Following performance of the first portion of the query, performance of a second portion of a query could include an estimation of a second input of a second function of the multi-function query. Performance of both the first portion and the second portion of the query could indicate a second level of completion, such as a 50% level of completion or a “level 2” completion. In addition, performance of each portion of the query and performance of each level of completion of the query can result in a different output of the query. For instance performance of both the first portion and the second portion of the query can result in a second output value of a query. The second output value can represent a second estimation of the requested information.

It should be appreciated that the above example does not limit the concept of performance of portions of a query as representative of levels of completion of queries. In particular, performance of a portion of a query could indicate any level of completion of a query associated with progression of the query. In an aspect, as a query operation is carried out towards completion new values associated with estimates of parts or inputs to functions dynamically change over time. For example, a first estimation for an input of a function may become more accurate over time replacing previous input estimations. According to this example, each time a new value replaces a previous value in a query computation, a new portion of the query is performed. Performance of a portion of a query can therefore indicate any aspect of performance associated with progression of a query.

In addition to search component 104, query service 102 can further comprise a management component 106. In an embodiment, management component 106 is configured to determine a degree of accuracy requested for requested information from data 112. In particular, when the search component 104 receives a request for information, management component 106 is configured to determine the degree of accuracy requested for the requested information and instruct the search component 104 to render the information in accordance with the degree of accuracy requested. As noted supra, in an aspect, performance of a portion of a query and/or the level of completion of a query indirectly relates to the degree of accuracy of the estimation of the requested information. According to this aspect, management component 106 can be configured to determine a degree of accuracy requested for requested information and instruct the search component 104 to perform a generated query so that the resulting outputted information is in accordance with the degree of accuracy requested. According to this aspect, the degree of accuracy requested dictates the level of completion of the query, wherein performance of a portion of the query indicates a level less than full completion. In another aspect, management component 106 is configured to determine a degree of accuracy requested for requested information and instruct the search component 104 to utilize stored pre-configured queries, stored components of queries, and/or stored results to known queries in order to render the requested information.

In an aspect, management component 106, is configured to determine a level of completion requested for a generated query. As noted above, a level of completion can indicate performance of a portion of a query or multiple portions of a query. In an aspect, the level of completion requested for a generated query relates to the degree of accuracy requested for requested information. For example, in an aspect search component 104 is configured to perform a query ranging in full completion to non-performance. Thus level of completion of a query indirectly relates to the accuracy of the output of the query. For example, if the query is performed to full completion, then the degree of accuracy of the result will be 100 percent. However, if a portion of the query is performed, the degree of accuracy will likely be less than 100 percent.

In an embodiment, the level of completion of a query is based on the number of estimates employed in a query determination and/or the number of functions completed. For example, a level of completion of a query could include completion of 75 percent of the associated functions. According to this aspect a portion of the query is perfumed where 3 out 4 functions are completed. In another example, a level of completion of a query could include employment of a one-part estimation, or a two part estimation or an estimation of the input for a single function.

In another embodiment, the degree of accuracy of the requested information or the level of completion of a query is dictated by a control protocol. According to this aspect, management component 106 can be configured to instruct search component 104 to render information in accordance with control protocols. According to this aspect, the degree of accuracy of requested information and/or the level of completion of a query is restricted and controlled based on predefined control functions. In an aspect, the control functions are outlined in data store 108. In an aspect, a control function can restrict performance of a query based on at least one of: a duration of time associated with performing a query, a cost associated with performing the query, a resource constraint associated with performing the query, a degree of accuracy associated with an estimate of requested information, a confidence level associated with an estimate of requested information, or a speed associated with determining an estimate of requested information. In an aspect, application of a control protocol results in a performance of a portion of a query.

In an example, management component 106 can instruct search component 106 to perform a generated query for a predetermined amount of time. According to this example, the search component can stop performing a query prior to completion when the predetermined duration of time is reached. As a result, the output of the query will be an estimate of the requested information. In another example, it may cost a server or user X amount of money to perform a query in full. According to this example, at the instruction of a user or server, management component 106 could instruct the search component 104 to perform a query until Y amount of money is employed, where Y is less than X. In yet another example, management component 106 could instruct the search component 104 to perform a query until a certain amount of energy, say 20 watts, is used up.

In another aspect, a control protocol can restrict performance of a query based on predetermined levels of completion, where a level of completion encompasses the above parameters. In particular, a level of completion could be regarded as level 1, level 2, and level 3 and so on. I should be appreciated that any naming scheme can be applied to indicate a level of completion of a query and any number of levels can be provided. For example, levels of completion could be denoted by colors, or levels of completion could represent a silver level, a gold level, a platinum level, and so on. A level of completion can be based on the application of a predefined control parameter. For example, a level of completion could be based on at least one of: a duration of time associated with performing a query, a cost associated with performing the query, a resource constraint associated with performing the query, a degree of accuracy associated with an estimate of requested information, a confidence level associated with an estimate of requested information, or a speed associated with determining an estimate of requested information.

In another aspect, management component 106 is configured to instruct the search component 104 to perform a query until a certain level of accuracy is achieved or certain level of confidence is achieved. For example, management component 106 can instruct search component 104 to render information with 100 percent accuracy. In another example, management component can instruct search component to render the information with 99 percent accuracy, 75 percent accuracy, and so on. Furthermore, according to the above embodiment, management component 106 is configured to instruct search component 104 to keep performing portions of a query until accuracy level or confidence interval is achieved.

A confidence level is a particular kind of interval estimate of a population parameter and is used to indicate the reliability of an estimate. It is an observed interval calculated from the observations associated with a result in principle different from sample to sample, that includes at least one parameter of interest, when a query is repeated. The degree to which a query result includes a parameter of interest is determined by the confidence level or confidence coefficient. The parameter of interest can include an aspect of an anticipated result, such as inclusion of key words, expected distributions of a result, and etc. In an aspect, the parameter of interest is based on a statistical model based on tracked data. Tracked data is discussed infra. A confidence level is intended to give the assurance that, if the statistical model is correct, then taken over all the data that might have been obtained, the procedure for generating and implementing a query would deliver a confidence interval that included the true value of the parameter of interest.

According to this aspect, management component 104 can employ a mechanism to evaluate the accuracy and/or confidence level of a result from a query prior to completion of the query. In an aspect, the query service can receive user input with hints describing aspects of the requested information and/or the parameter of interest. In another aspect, management component can employ tracked results of past tracked queries as discussed supra, in order to determine accuracy and confidence levels associated with similar current queries.

As noted above, in an embodiment, management component 106 is configured to direct search component 104 to perform a query in accordance with a degree of accuracy, a level of completion, or a control function. It should be appreciated that in general, each of a degree of accuracy, a level of completion or a control function are similar in purpose and function. In particular, each of a degree of accuracy, a level of completion, or a control function relate to performance of some portion of a query and rendering of a result of the query in some form. The form can be in fact the actual requested information or an estimate of the requested information. In an aspect, the management component 106 is configured to determine a degree of accuracy requested for the information, and instruct the search component to render the information based on the degree of accuracy requested. For instance, the search component 104 can generate a query configured to determine the requested information and the management component 106 is configured to instruct the search component to perform the query based on the degree of accuracy requested for the information. For example, the degree of accuracy may be low, medium or high. In another example, the degree of accuracy may indicate a level of completion of the query. In turn, the management component 106 is configured to instruct the search component 104 to perform a portion of the query. In an aspect, the management component 106 can instruct the search component 104 to perform a portion of the query based on at least one of a duration of time associated with performing the query, a cost associated with performing the query, or a resource constraint associated with performing the query, and wherein the search component is configured to render an estimation of the information.

In another embodiment, the management component 106 is further configured to instruct the search component 104 to perform the full query if the degree of accuracy requested is above a predetermined threshold and to instruct the search component to perform a portion of the query if the degree of accuracy requested is below a predetermined threshold. In another aspect, the management component 106 can be configured to instruct the search component 104 to perform a portion of a query first and later perform the full query. According to this aspect, in response to a request, a user may receive a quick estimated answer to requested information and later receive a more accurate answer or the actual answer. Still in yet another aspect discussed infra, the management component 106 is configured to direct the search component 104 to employ stored information in order to facilitate rendering information based on a degree of accuracy requested for the information.

Management component 106 can employ a variety of protocols and techniques in order to determine the degree of accuracy requested for requested information. In an aspect, management component 106 can be configured to perform a query so as to render information with a preconfigured degree of accuracy. According to this aspect, regardless of a user's request, management component 106 can direct the search component 104 to carry out a query according to predetermined parameters. For example, management component 106 can direct search component 104 to perform a query according to a predetermined level of completion, in accordance with pre-configured control protocols, or to a predetermined degree of accuracy or confidence level.

In an embodiment, the predetermined parameters are associated with a user account or profile. According to this embodiment, a user can subscribe to query service and subscribe to receive query determinations based on a predetermined level of completion, in accordance with pre-configured control protocols, or to a predetermined degree of accuracy or confidence levels. For example a user can have a silver membership, a gold membership or a platinum membership and receive answers to query requests in accordance with his/her membership plan. For example, a platinum membership may cost more than a gold or silver membership but provide a user with quicker and more accurate answers to query requests. Data store 108 can store instructions which define levels of completion, control protocols, and/or degrees of accuracy or confidence levels for a user. Management component 106 can identify a user and/or user account associated with a query request and direct the search component 104 to render the information in accordance with the user's account.

In another embodiment, the management component 106 can determine the degree of accuracy requested for requested information based on a user's request. In particular, as discussed infra, the management component 106 is configured to employ analysis and inference techniques in order to intelligently determine the method for producing an answer to a user's request. For example, management component can intelligently determine what level of completion of a query is needed, what portions of a query to perform, when to perform them, and what control protocols to employ. Still as discussed supra, management component 106 is configured to determine whether search component even needs to generate and perform a query. According to this aspect, for example, search component can employed stored information to facilitate rendering an answer to a query request.

According to another aspect, management component 106 is configured to dynamically modify a query generated by search component 104 in order to optimize results. In particular, management component 106 is configured to direct search component 104 to perform aspects or portions of a generated query according to a priority order. For example, management component 106 can employ algebraic properties of a query computation to direct search component 104 to perform functions of a query according to a priority order. In an aspect, the priority order for performance of functions can be associated with a cost or resources requested to perform the function. For instance, the management component 106 can determine the functions from a set of functions which cost less to perform or consume less resources than other functions. The management component 106 can in turn order the search component to perform the cost or resource saving functions first.

In another example the priority order for performing the functions can be based on time associated with the data 112. For instance, a time associated with the data 112 can include a time of receipt of the data. In an example, data 112 can be dynamic and constantly updating. If certain data requested to perform a function of a query has not been updated, generated or received yet, management component 106 is configured to push back performance of the function until the data is received. Similarly, where an input to a function includes a subset of the data 112, determining the subset and/or an estimate of the subset may take a substantial amount of time. As a result, management component 106 can push back performance of the function requiring the subset until the subset or an estimate of the subset, has been determined Directionality of the data.

In yet another aspect, the priority order for performing the functions can be based on a degree of accuracy requested for or a associated with the determining en estimation of requested information. According to this aspect, the management component 106 can determine a weight to a apply to functions of a query. The weight can account for the degree of contribution or importance of a function in effecting the accuracy of a query result. The management component can in turn direct the search component 104 to perform the queries in order of their weight, giving first priority to function having a higher weight. Still in yet another aspect, the priority order for performing the functions of a query can be based on increasing the efficiency associated with determining an estimation of the requested information.

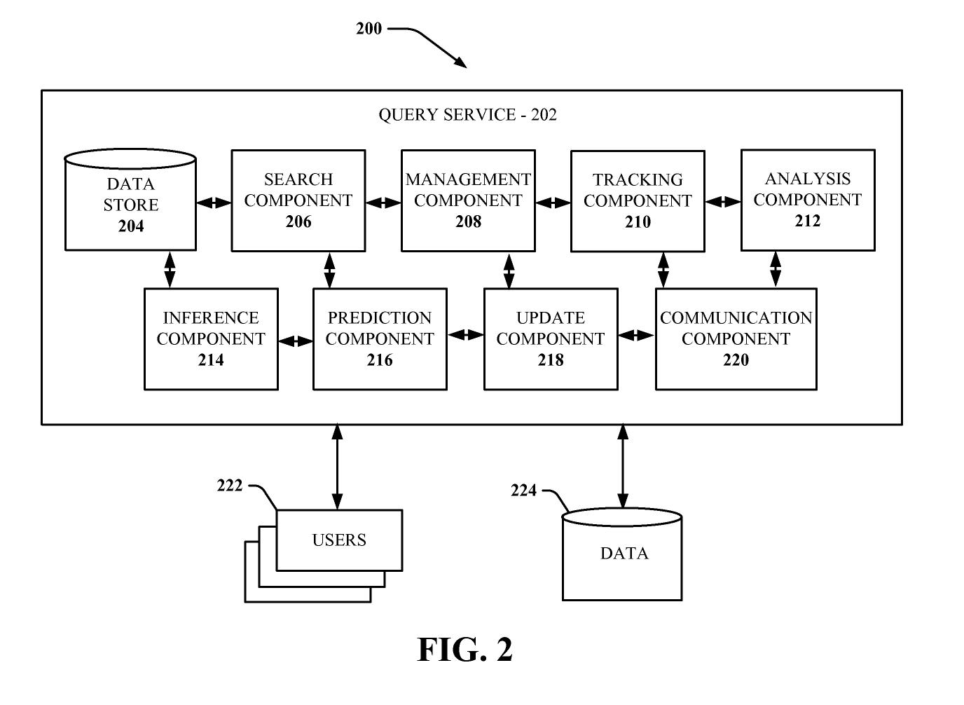

Still in yet another aspect, as discussed infra, in an aspect, information associated with query requests including the inputs for the requests, the query computations performed, the information generated during performance of the queries and the outputs of the queries can be tracked and stored. In another aspect, information associated with simulated queries can be generated and stored. As discussed with reference to FIG. 2, an analysis component 212 can determine correlations between a new query request and an associated query with the stored and/or tracked information. According to this aspect, where any of the stored information can be applied to a new search request or query, search component 104 can employ the stored information. For example, assuming a subset of information requested for an input to a function for a current query has been previously determined and stored. Rather than generating the subset of the information all over again, search component 104 can simply employed the stored subset. Therefore, in an aspect, where functions can employ tracked and/or stored information, management component can direct search component 104 to perform those function prior to other functions.

It should be appreciated that any of the above mechanisms can be employed by the management component alone or in combination in order to determine a priority order for functions of a query.

Referring now to FIG. 2, presented is another embodiment of a system 200 configured to facilitate rendering efficient query result. Similar to system 100, system 200 includes a query service 202, users 222, and data 224. Also similar to system 100, query service includes data store 204, search component 206, and management component 208. It should be appreciated query service 202, users 222, data 224, data store 204, search component 206, and management component 208, includes at least the elements and attributes of query service 102, users 110, and data 112, data store 108, search component 104, and management component 106. In addition, query service 202 includes tracking component 210, analysis component, 212, inference component 214, prediction component 216, update component 218, and communication component 220. Additional elements and attributes of query service 202, users 222, data 224, data store 204, search component 206, and management component 208 attributable at least in part to tracking component 210, analysis component, 212, inference component 214, prediction component 216, update component 218, and communication component 220, are discussed below.

In an embodiment, tracking component 210 is configured to track information associated with query requests. Further, any information tracked by tracking component 210 can be stored in data store 204 for future use and analysis. In particular, tracking component 210 is configured to track what information is requested, they type of information requested and the form it is requested in. For example, tracking component 210 can track what questions a user presents query service 202, and the key terms and operators employed to form a request. In an aspect, tracking component 210 is also configured to track where a query request comes from. For example, in an aspect, query service 202 can facilitate queries for multiple users 222 and tacking component 210 is configured to track what user 222 requests information from query service 202. In another example, tracking component 210 is configured to track what data is associated with a query inputs for request, such as data that is bound to check boxes employed to formulate a request for information.

Tracking component 210 is further configured to track the composition of queries generated in response to a query request. For example, tracking component 210 can associate a generated query with requested information. Tracking component can also track the performance of a query. According to this aspect, tracking component can track the level of completion of a query, the portions of the query performed, control protocols employed during performance of the query, the estimated values and inputs associated with performance of the query, and the sampling and statistical tools employed to determine the estimated values. In addition, tracking component 210 is configured to track the data associated with performance of a query. For example, tracking component is configured to determine the subsets of data 224 employed in performing a query, including samples of data associated with performing a query. In yet another aspect, tracking component 210 is configured to track answers to queries. For example, tracking component 210 is configured to track estimations of requested information produces as an output to a query. Similarly, tracking component 210 is configured to track actual answer provided by search component 206 in response to full performance of a query.

In an embodiment, in order to facilitate conditioning of performance of query, a user can provide search component 206 feedback to a query request. Tracking component 210 can further track user feedback. According to this aspect, search component 206 can perform a generated query to a first level of completion less than full completion and produce an estimated answer to the query request. In response, the user can indicate to the search component 206 whether the estimated answer is acceptable, unacceptable, on-track or off-track. As a result management component 208 can direct search component 206 to stop performance of a query, continue performance of query, or modify performance of the query. For example, where a user indicates an estimated answer is acceptable, the search component may stop performance of a query. In another example, where a user indicates a result is unacceptable yet on-track, the search component may continue performance of the query. In yet another example, where the user indicates performance of the query is unacceptable and off-track, the search component may modify the performance of the query and/or abort the query and generate a new query. As discussed infra, in an aspect, analysis component 212 can facilitate search component 206 in modifying a query.

In another aspect, a user can provide feedback regarding the content of information rendered by search component 206 in response to a query request. For example, a user can provide the search component with information regarding the distribution of an estimated result, such as whether the distribution is ordered or Gausian. According to this aspect, the user can provide the search component hints as to what the user expects an answer to include or look like. In return, analysis component 212 can employ the feedback to facilitate determining modification to queries to direct query performance. In addition, analysis component 212 can employ the feedback to facilitate determining the accuracy of an estimated result and/or confidence levels associated with an estimated result.

In addition, tracking component 210 is configured to track context information associated with query requests. In an aspect, context information can include associated with a user's physical environment. For example, in order to interact with query service 202, a user can employ a computing device such a laptop computer or a smartphone. According to this aspect, context information can include the physical location of a user, such as a global positioning system determined location of the user. In another aspect, the physical location can include specific indoor and locations such as a building, a store, a concert hall or a stadium. Further, context information can include the environment surrounding a user device, including other individual, and the activity of those individuals. For example, the environment surrounding a user's could include the identity of another individual near the user and the other individuals online activities.

In another aspect, context information can include the operating levels and workloads of hardware associated with performing query requests. According this example, tracking component can associate types of query requests and performance of those request and related output of those request with performance of hardware. In another example, tracking component can track times associated with performance of query requests. For example, tracking component 210 can track traffic patterns and thus analysis component can later determine, when traffic volume is high, medium, low, and etc.

Referring now to analysis component 212 and inference component 214, in an embodiment, analysis component 212 and inference component 214 are configured to assist management component 208 in making decisions regarding rendering answers to query inquires. In particular, as discussed supra, in an aspect, management component 208 is configured to determine a degree of accuracy requested for information requested by a user from query service 202. In an aspect, management component 208 can intelligently determine requirements of a query computation, what level of completion of a query is needed, what portions of a query to perform, when to perform them, and what control protocols to employ. Management component 208 is configured to determine whether search component 206 even needs to generate and perform a query.

In an aspect, in order to determine the degree of accuracy requested for information, analysis component 212 is configured to analyze a request for information and determine the degree of accuracy requested for a response to the request based on the request itself. In particular, analysis component 212 is configured to analyze a request for information and determine what type of answer the user is looking for. According to this aspect, analysis component 212 is configured to analyze the content of a request and employ stored information in data store 204 associating content data with accuracy requirements, answers, and query requirements. In an aspect, the information is tracked information. In another aspect, the information is pre-configured in data store 204. In another aspect, the information is generated by analysis component based on tracked information.

Inference component 214 is configured to assist analysis component 214 in determining the degree of accuracy requested of requested information and the type of answer a user is looking for in order to facilitate management component 208 in determining a method to render a user the requested information accordingly. Inference component 214 employs explicitly and/or implicitly trained classifiers in connection with performing inference and/or probabilistic determinations and/or statistical-based determinations as in accordance with one or more aspects of the disclosed subject matter as described herein. As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. In particular, captured data includes all information tracked by tracking component 210.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In an aspect, analysis component can determine what type of answer a user is looking for based on content of the request, including key terms, combinations of key terms and combinations of key terms and operators employed. According to this aspect, data store 204 can associate key terms, combinations of key terms, and combinations of key terms with operators, with types of requests. The types of requests can further be associated with degrees of accuracy requested for the request. For example, a type of a request could relate to location based request, person requests, or event requests. In another aspect, a type of request could associate a request with a particular subset of data 224 or particular query operations. It should be appreciated that any number of types of requests ranging from broad to narrow are contemplated in accordance with the subject disclosure. For example, a type of request could include a specific question or a category in which a question falls.

In another aspect, a type of request can account for the directionality of data. For example, an answer to a query request may be time sensitive. For example, a user may desire to know what time the cable man is scheduled to arrive so that the user can be home for when he arrives. For example, according to this aspect, an accurate indication of between 10 am and 12 am is needed. However, greater accuracy is needed for the lower bound of the time frame, for if the lower time frame earlier than 10 am, the user may miss the cable man whereas if the upper time frame is later than 12 pm, the user will have already arrived at home in anticipation for an earlier arrival. Accordingly, when accounting for the directionality of the information, the management component 208 may direct the search component to give priority or require more accuracy from the functions or aspects of a query that accounts for the lower bound of the time frame desired by the query request.

Therefore in an aspect, analysis component 212 is configured to employ data store 204 to identify a type of request based on the content of the request. Once analysis component 212 determines a type of request it can also employ data store 204 to determine the degree of accuracy requested for the type of request. Management component 208 is further configured to determine a method for rendering requested information in accordance with the degree of accuracy requested for the type. For, example, the management component 208 may direct search component to perform a query in accordance with control protocols until a desired level of completion is achieved or to perform a query so as to achieve a detectable degree of accuracy or confidence level.

In an aspect, analysis component 212 is configured to analyze a request to determine the degree of accuracy requested for the information requested based on tracked information. For example, in an aspect, inference component 214 can infer a type of request based on similarities to a prior tracked request and employ the degree of accuracy requested for the type of request. In another aspect, analysis component 212 is configured to analyze tracked information in order to identify correlations between aspects of a current request and the tracked information in order to render an answer to the current query request in accordance with the degree of accuracy requested for the requested information. In particular, analysis component 212 can analyze correlations between a new request and a previous request related to content or type casts and employ learned elements from the previous in order to optimize the new request.

In response to determined correlations between a current query and any tracked or stored information, management component 208 can employ one or more aspects of a previous request and that are related to a current query operation for performance of the current query operation. In an aspect, analysis component 212 can apply the same aspects of the previous request against then request where the requests are the same. In another aspect, the management component 208 can employ a portion of the aspects of the previous query request against a new request. In an aspect, the management component 208 can employ the degree of accuracy that was requested for one or more previous similar requests and apply similar requirements to the new request. In another aspect, the management component can employ one or more of the query functions employed in the query operation of the past request in the new request, or a priority order of functions employed in a previous request. Further management component 208 can employ one or more previously determined estimations of inputs for the query functions, such as sample and/or subset of data 224. In addition, management component 208 can employ one or more previously determined one or more previously determined outputs of the query functions. In another aspect, management component can apply the control protocols employed in the previous request against a new request.

In view of the above, analysis component 212 and inference component 214 are further configured to analyze patterns in tracked information in order to infer generating and performing a query for a new request. For example, in a competitive game of chess, masters of the game initially employ a series of known moves prior to reaching a point where unanticipated moves are made. These initial moves are well known and written in a book. In accordance with the same theory, analysis component 212 can analyze tracked query information, including inputs, computations employed, the functions requested in the computations, data employed in the computations, and the manner of performance of the computations including the level of completion of the computations, in order to learn how to generate and perform a future query.

In particular, inference component 214 can recognize a query type or similarities between queries and employ learned “moves” in a new query. For example, inference component 214 can examine a new request for information and determine that it appears a user is looking for X. In response, analysis component 212 can analyze previous query information related to X and employ the previous query information to generate and perform the new request for information. In accordance with the above example, analysis component can 212 determine the degree of accuracy requested for the new requested information, the functions requested for a query computation to produce the requested information, the manner of performance of the functions, inputs for the functions, and control protocols to employ. Management component 208 can then direct search component 206 to generate and perform a query based on at least one of the degree of the accuracy requested for the new requested information, the functions requested for the query computation to produce the requested information, the manner of performance of the functions, inputs for the functions, and the control protocols to employ.

In view of the above example, analysis component 212 can also employ tracked user feedback information in order to optimize new queries. In essence, analysis component 212 can learn from previous mistakes or from previous actions which worked. As a result, analysis component 212 can determine query operations and manners of performance of those query operation that facilitate determining information based prior queries and prior performance of those queries which rendered acceptable answers in the past. For example, a function of a query computation may generate data joins. Where data joins were “on track” according to user feedback, analysis component can employ a similar data join in the future for a similar request, without undergoing the full query computation.

In another aspect, analysis component 212 is configured to find a previous similar query based new query request and determine a previous answer for the similar query stored in a data store 224. According to this aspect, analysis component 212 can capitalize on previous answer determinations from data 224 for same or similar questions. Analysis component 212 can then provide the management component 208 with the stored answer. For instance, inference component 214 can examine a new request for information and determine that it appears a user is looking for X. Analysis component 212 can provide the management component 208 with a previous answer for similar search request for X or information related to X. Search component 206 can then provide a user with the previous answer in response to his/her request without wasting time and resources on a new query. Later, if the user is unsatisfied with the answer or would still like the search component to perform a new query, the user could instruct the search component 206 to continue with a new query. For example, when providing an answer for a new query based a previous answer for a same or similar query, it can be appreciated that the data for which the previous query was based has changed. Accordingly, a user may desire a more up to date answer based on a new query request. Nevertheless, management component 208 may employ aspects of the previous query which are not affected by changed data 224 employed in the new query.

Further, in an embodiment, analysis component 212 can employ tracked context information in order to facilitate management component in directing search component 206 how to go about rendering an answer to a query request. According to this aspect, where context information includes a user's physical environment, inference component can infer the type information the user is requesting is related to or limited by the user's physical environment. As a result, management component 208 is configured to direct the search component to generate and or perform a query in accordance with the user's physical environment. For example, a user may request to girls with the last name “Poff.” The user may further be located in Cleveland. The management component 208 can thus direct the search component to generate and perform a query to find girls with the last name “Poff” who are located in Cleveland, thus condensing resources requested for an extensive search for the girls named “Poff” say in the entire United States.

In another aspect, where context information includes operating levels and parameters of hardware associated with query service 202, management component 208 can direct search component to employ hardware in a query that optimizes allocation of resources. According to his aspect, analysis component 212 can determine hardware components requested to generate requested information, including one or more computers and data stores holding data 224. Analysis component 212 can further determine the current operating levels associated with hardware requested to perform a query associated with requested information. As a result, management component 208 can direct search component 206 to carry out a query based on the current operating levels of requested hardware. Therefore search component 206 can optimize performance of a generated query by allocating the workload to the appropriate hardware. For example, in an aspect, management component 208 can direct search component 206 to perform functions X and Y of a query operation on computers A and B respectively based on the operating levels of computers A and B and the hardware requirements for performance of functions X and Y. For example, computer A may be a remote computer affiliated with query service and employ a local data store with data 224.

In another aspect, analysis component 212 can employ tracked information to learn traffic patterns associated with query requests. For example, analysis component can determine the types of resources and hardware associated with a request and the operating levels of those resources and hardware at different times of day. For instances, analysis component 212 may determine that a particular query request will take longer at 2 pm as opposed to 2 am based on the type of request and the resources available, including hardware, to perform the request. As a result, in an aspect, management component 208 can direct search component to generate and perform a query based on current traffic patterns associated with performance of the query.

For example, a user may request information at 2 pm at which time traffic volume associated with query service 202 is high with regards to rendering the requested information. As a result, management component 208 can direct search component 206 to generate a query and perform the query to a first level of completion that relates to an answer having an 85 percent degree of accuracy. However, the user may request the same information at 2 am at which time traffic volume associated with the query service is low. As a result, the management component 208 can direct the search component 206 to generate a query and perform the query to a second level of completion that relates to an answer having a 95 percent degree of accuracy.

In addition, as seen in FIG. 2, query service 202 can include a prediction component 216. Prediction component 216 is configured to anticipate or predict queries that query service may receive and simulate performance of the predicted queries. The predicted queries and any information associated therewith can be stored in data store 204 for future employment in the manner in which tracked data can be employed discussed supra. For example, management component 208 can employ pre-computed results to queries against current similar queries. According to an aspect, in response to predicted queries, prediction component 216 is configured to proactively join and categorize data 224. For example, when data 224 has been organized, search component 206 can more efficiently parse the data 224 when performing a query.

Referring back to FIG. 2, update component 218 is configured to provide a user with updated answers for requested information. For example, in an aspect, management component 208 is configured to direct search component to render multiple answers to a user for requested information based on different levels of completer. For example, management component 208 can direct search component 206 to perform a query to a first level of completion and render a first estimation of the requested information. The management component 208 can further direct search component 206 to continue performing a query to a second level of completion, a third level of completion, and so on. Each time the search component completes a level of completion, the search component can render a new estimate of the requested information. According to this aspect, update component 218 is configured to provide the user with the new estimate of the requested information. In particular the update component 218 is configured to determine if a new estimate of the requested information is different from a previous estimate, and if so, provide the user with the new or “updated” estimation of the requested information.

In yet another aspect, as discussed supra, management component 208 can direct search component 206 to render an answer to requested information based on a stored answer associated with the user's request. Later, management component 208 can direct search component 206 to generate and perform a query to find the requested information. According to this aspect, update component 218 is configured to determine if the answer generated in based on the stored information is different from the answer based on the generated query. If the answer is different, update component 218 is configured to provide the user with the new answer based on the query.

Still in yet another aspect, update component 218 is configured to re-run query requests for a user when data 224 employed in the query request has changed. According to this aspect, update component 218 is configured to monitor data 224 following performance of a query or during performance of a query for a predetermined time frame. In an aspect, update component is configured to monitor data 224 for an hour, three hours, twenty four hours, a week, and so on. According to this aspect, update component is configured to determine when data employed in a query has changed, re-run the query, and provide the user with an updated answer.

In addition, query service can include a communication component 220. Communication component 220 is configured to facilitate communicating query results to a user. In an aspect, communication component 220 is configured to send a query result to a user as an electronic message, such as an email, a multimedia messaging service (MMS) message, a text message, or an instant message. For example, as noted supra, update component 218 is configured to re-run queries and provide a user with the result if the new answer is different from a previous answer. Thus in an aspect, communication component 220 is configured to send a user a notification via email or another messaging form, providing an updated answer to a query result.

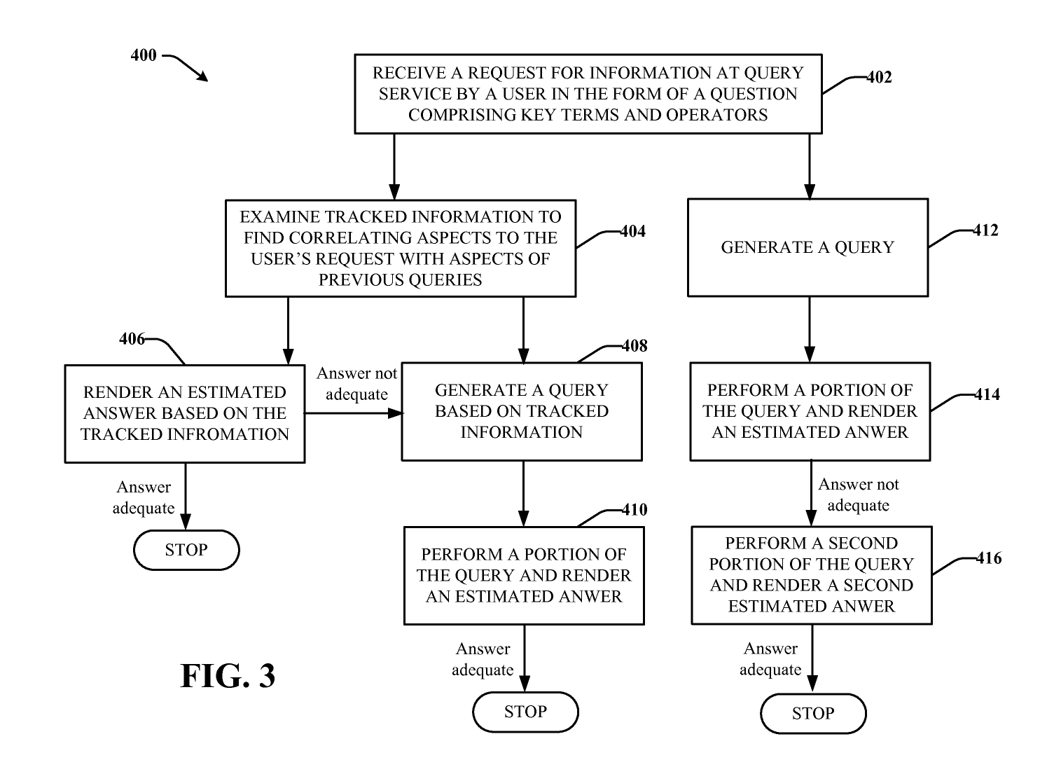

Turning now FIG. 3, illustrated is a flow diagram 300 exemplifying an application of query service 202. With reference to numeral 302, query service 202 can receive a request for information by a user in the form of a question comprising key terms and operators. In an aspect, in response, at 304, the query service can examine tracked information to find correlating aspects of the user's request with previous queries. For example, the query service 202 can identify a past same or similar query request and at 306, the query service can render an estimated answer based on the tracked information. According to this example, query service 202 can render the user the same answer from the past same and similar query immediately and without going through an extensive query. In an aspect, the query service 202 can provide the user with a prompt asking whether the answer is adequate. If the user accepts the answer the query service can stop responding to the user's query request. However, if the user does not accept the answer, the query service can continue to reference numeral 308 discussed next.

In another aspect, at reference numeral 304, the query service can examine tracked information to find correlating aspect of the user's request with previous queries. For example, the query service 202 can identify a past same or similar query request and at 308, the query service can generate a query based on the tracked information. For instance, the query service 202 can generate a query with some of the functions employed in a past similar query and/or previously determined outputs for those functions. At 310, the query service 202 can then perform a portion of the query to render an estimated answer. For example, the query service 202 can perform the query to a level of completion less than full completion by performing the query for a predetermined amount of time and then stopping performance of the query. If the user determines the estimated answer is acceptable, then the query is complete.

In yet another aspect, at 312, in response to receiving the query request, the query service can generate a query. For example, the query can comprise multiple functions. At 314, the query service can perform a portion of the query and render an estimated answer. For example, the query service can employ estimated values for the outputs of one or more of the functions. Then if the query service or the user determines the estimated answer is not adequate, at 316, the query service can perform a second portion of the query and render a second estimated answer. For example, the query service can employ fewer estimated values for the outputs of the functions than actual values. Then, when the user or the query service determines that the second estimated answer (or a third, fourth, and etc. estimated answer for that matter) is acceptable, the query is complete.

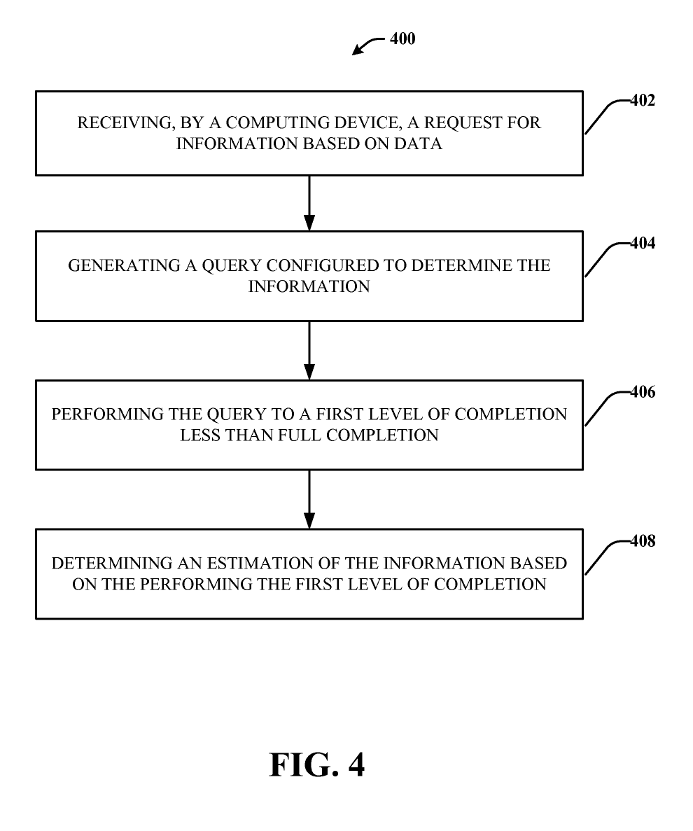

FIGS. 4-8 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be requested to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 4, presented is an exemplary non-limiting embodiment of a method 400 for determining an estimated answer to a query result. Generally, at reference numeral 402, a request for information based on data can be received by a computing device. For example a request for information based on data can include a question regarding finding a particular subset of a big dataset. In response, at reference numeral 404, query can be generated that is configured to determine the information. For example, the query can include a computation that comprises of one or more parts or functions. At reference numeral 406, the query can be performed to a first level of completion less than full completion. For instance, a portion of the parts or functions of the query can be completed or estimated values for inputs and/or outputs of the functions of the query computation can be employed. Then, at 408, an estimation of the information can be determined based on the performing the first level of completion.

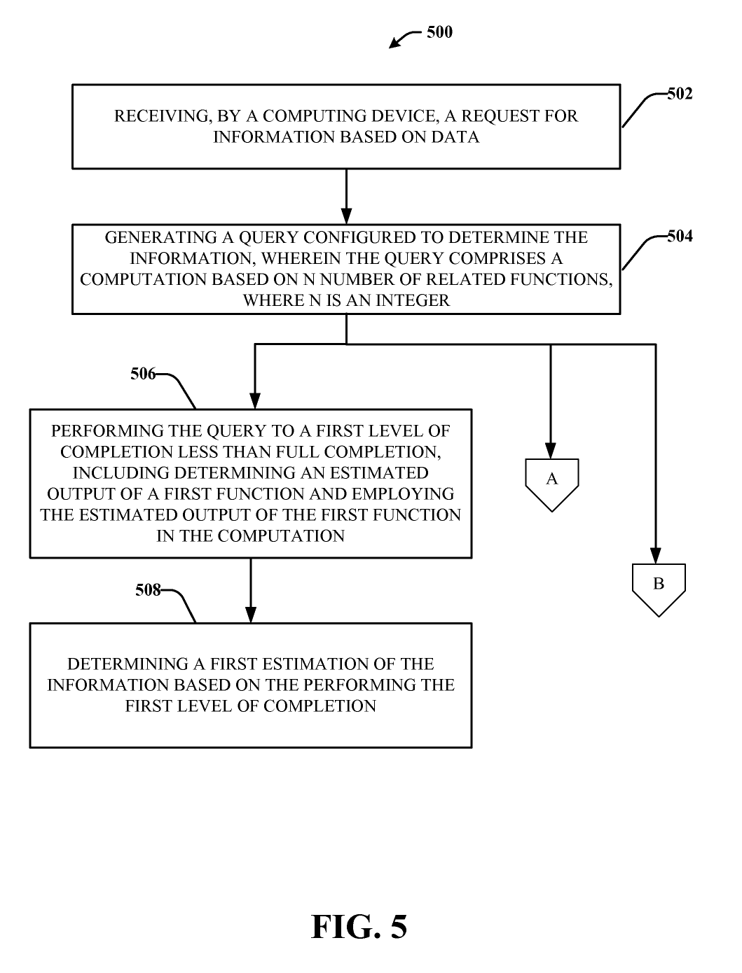

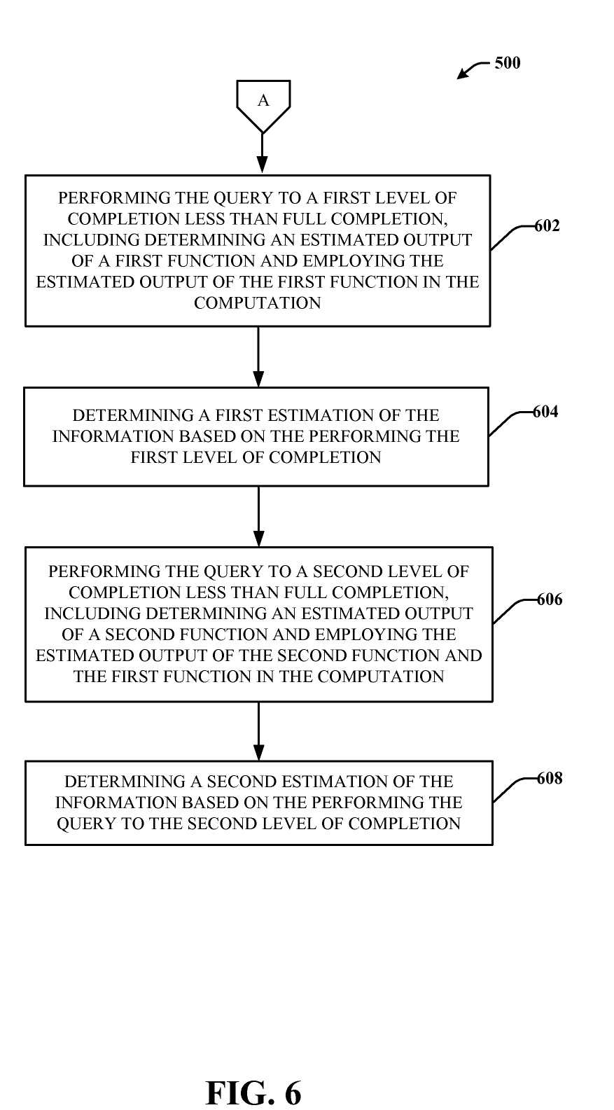

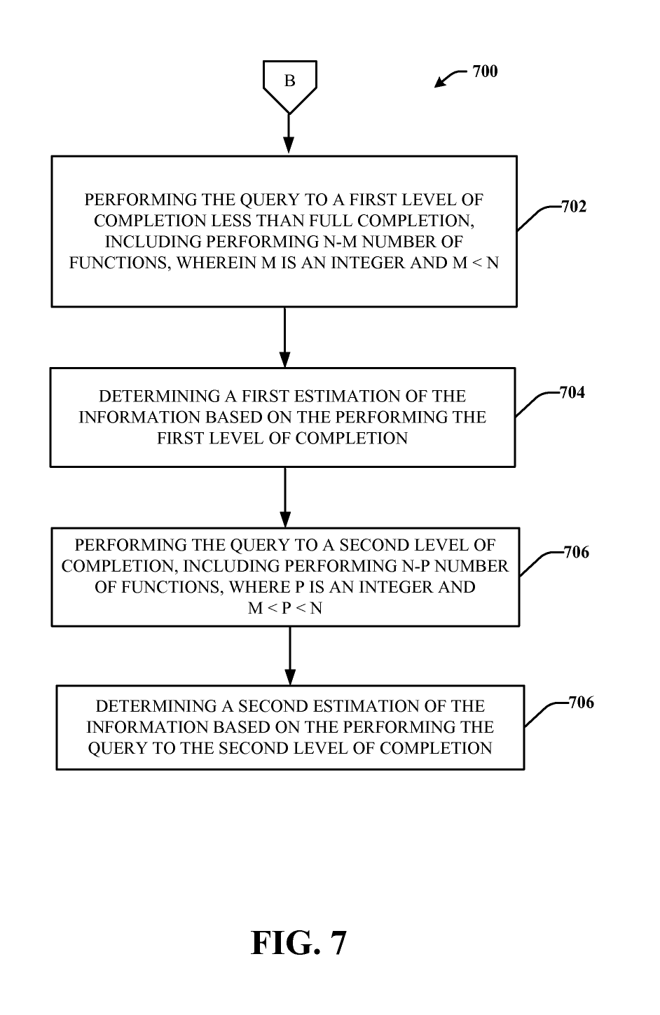

Referring now to FIG. 5, an exemplary method 500 for generating an estimated answer to a query is depicted. Generally, at reference numeral 502, a request for information based on data can be received by a computing device. For example a request for information based on data can include a question regarding finding a particular subset of a big dataset. In response, at reference numeral 504, query can be generated that is configured to determine the information. In particular the query can comprise of a computation based on N number of related functions where N is an integer. For example, the query can include an associative or distributive computation that comprises of one or more parts or functions. Following generation of a query, method 500 can continue in a variety of directions included continuation with reference numerals 506 and 508, continuation with direction A described in FIG. 6 or continuation with direction B described in FIG. 7.

Referring back to method 500, at reference numeral 506, the query can be performed to a first level of completion less than full completion, including determining an estimated output of a first function and employing the estimated output of the first function in the computation. For example, the estimated output of the first function could be attributed to a sample of a requested subset of the data. Then, at 508, an estimation of the first information can be determined based on the performing the first level of completion.

With reference to FIG. 6, presented is another exemplary method 600 for determining an estimated answer to a query request with respect to direction A presented in method 500 of FIG. 5. Similar to an aspect of process 500, at reference numeral 602 the query can be performed to a first level of completion less than full completion, including determining an estimated output of a first function and employing the estimated output of the first function in the computation. For example, the estimated output of the first function could be attributed to a sample of a requested subset of the data. Then, at 608, an estimation of the first information can be determined based on the performing the first level of completion. In an aspect, at this point the query service 102 or 202 disclosed herein or a user can determine if the first estimation of the information is acceptable. For example, the query service can determine if the first estimation of the information has reached a requested degree of accuracy or confidence level. In another example, the query service can determine whether an applicable control protocol is satisfied. According to this example, the query service can determine whether the query has been performed for a requested duration of time or to a requested cost cap. In another aspect, the search component can be configured to carry out a query to a predetermined level of completion such as a first level, a second level, a third level, and so on.

If the query service or user determines that the first estimation of the information is unacceptable or if the query service is configured to perform additional levels of completion, then at 606 the query can be performed to a second level of completion less than full completion, including determining an estimated output of a second function and employing the estimated output of the first function and the second function in the computation. In an aspect although not depicted, the second level of completion can be attributed to determining a new more accurate estimated output of the first function. Then, at 608, an estimation of the first information can be determined based on the performing the first level of completion. It should be appreciated that method 600 can be repeated multiple times to multiple levels of completion until a resulting estimated answer is acceptable in terms of accuracy or a control protocol is satisfied.

With reference now to FIG. 7, presented is another exemplary method 700 for determining an estimated answer to a query request with respect to direction B presented in method 500 of FIG. 5. Similar to an aspect of process 500, at reference numeral 702 the query can be performed to a first level of completion less than full completion. In particular, the query can be performed to a first level of completion less than full completion including performing N−M number of functions, where M<N. In other words, a first subset of the number of function N of the query can be performed. Then at 704, a first estimation of the information can be determined based on the performing the first level of completion.

In an aspect, at this point the query service 102 or 202 disclosed herein or a user can determine if the first estimation of the information is acceptable. For example, the query service can determine if the first estimation of the information has reached a requested degree of accuracy or confidence level. In another example, the query service can determine whether an applicable control protocol is satisfied. According to this example, the query service can determine whether the query has been performed for a requested duration of time or to a requested cost cap. In another aspect, the search component can be configured to carry out a query to a predetermined level of completion such as a first level, a second level, a third level, and so on.

If the query service or user determines that the first estimation of the information is unacceptable or if the query service is configured to perform additional levels of completion, then at 706 the query can be performed to a second level of completion less than full completion, including performing N−P number of functions where P is an integer and M<P<N. In other words, a second level of completion can include performance of a different subset of the number of functions of a query. In an aspect the different subset can include some or none of the functions of the first subset. Then, at 708, a second estimation of information can be determined based on the performing the query to the second level of completion. It should be appreciated that process 700 can be repeated multiple times to multiple levels of completion until a resulting estimated answer is acceptable in terms of accuracy or a control protocol is satisfied.

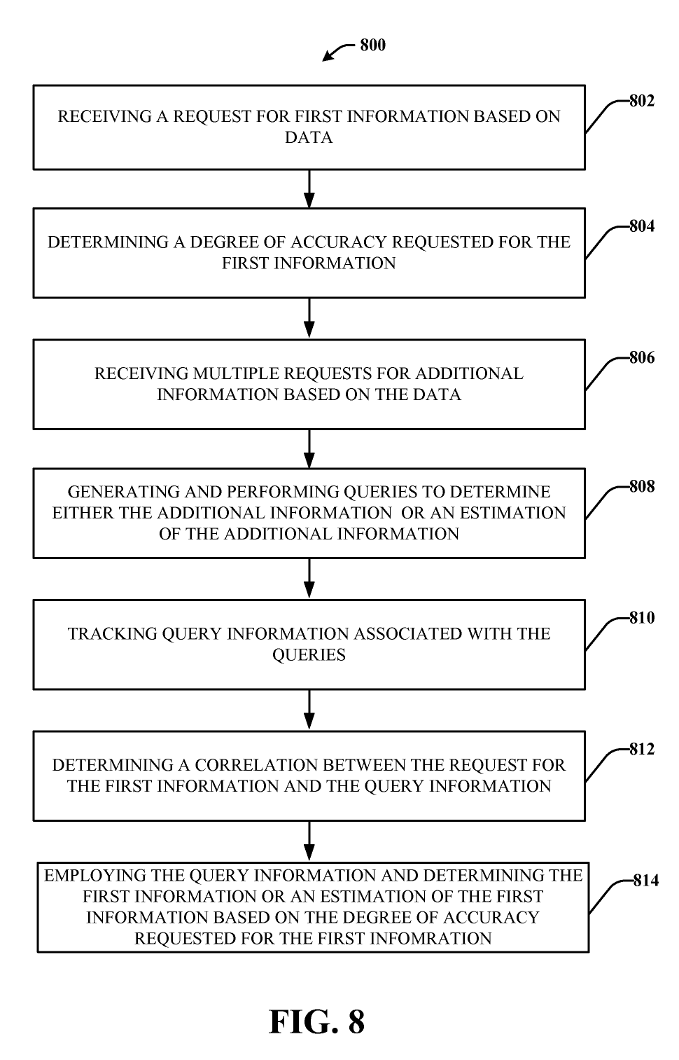

Turning now to FIG. 8, presented is a non-limiting embodiment of a method 800 for rendering an answer to a query request in accordance with a degree of accuracy requested for the answer. With reference to numeral 802, a request for first information based on data can be received. Then at 804, a degree of accuracy requested for the first information is determined. At 806, multiple additional requests for information based on the data can also be received. In response, at 808, queries can be generated and performed to determine either the additional information or an estimation of the additional information. At 810, query information associated with the queries can be tracked. For example, the query information can include input key terms employed by a search component to generate query computations, the functions associated with the query computations, estimated and actual input and output values associated with the functions, control protocols applied to the query computations, and actual or estimated output values for the query functions.

Continuing with reference numeral 812, a correlation between the request for the first information and the query information can be determined. For example, search component can recognize a correlation between key terms and aspects of tracked query computations associated with the key terms. Then at 814, the query information can be employed to determine the first information based on the degree of accuracy requested for the first information. For example, a past tracked output value of a past tracked function or combination of functions that are also included in a query computation generated to determine the first information can be employ in the query computation when performed. In another aspect, an answer of a past tracked query computation based on a same or similar search request as the request for the first information can be employed to determine the first information without the generation and performance of a new query.

### Exemplary Networked and Distributed Environments

One of ordinary skill in the art can appreciate that the various embodiments of query services and related components described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the query mechanisms as described herein for various embodiments of the subject disclosure.

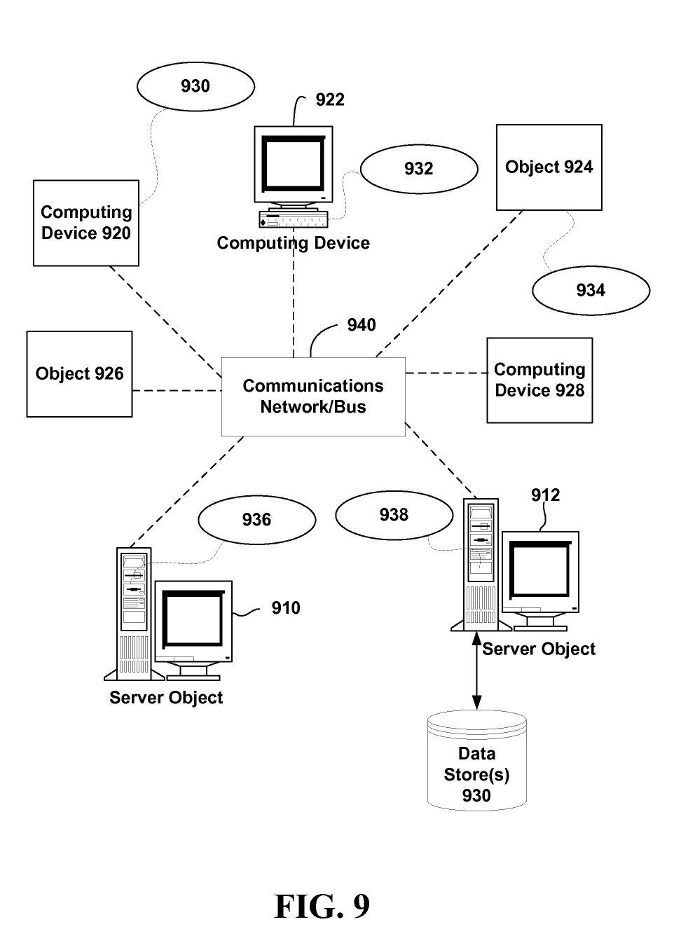

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as PDAs, audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object 910, 912, etc. or computing objects or devices 920, 922, 924, 926, 928, etc. can also contain an application, such as applications 930, 932, 934, 936, 938, that might make use of an API, or other object, software, firmware and/or hardware, suitable for communication with or implementation of the query services and related components provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the query services and related components as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc. provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting transaction services or tasks that may implicate the techniques for dynamic composition systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing read set validation or phantom checking can be provided standalone, or distributed across multiple computing devices or objects.

In a network environment in which the communications network/bus 940 is the Internet, for example, the computing objects 910, 912, etc. can be Web servers with which the client computing objects or devices 920, 922, 924, 926, 928, etc. communicate via any of a number of known protocols, such as the hypertext transfer protocol (HTTP). Servers 910, 912, etc. may also serve as client computing objects or devices 920, 922, 924, 926, 928, etc., as may be characteristic of a distributed computing environment.

### Exemplary Computing Device

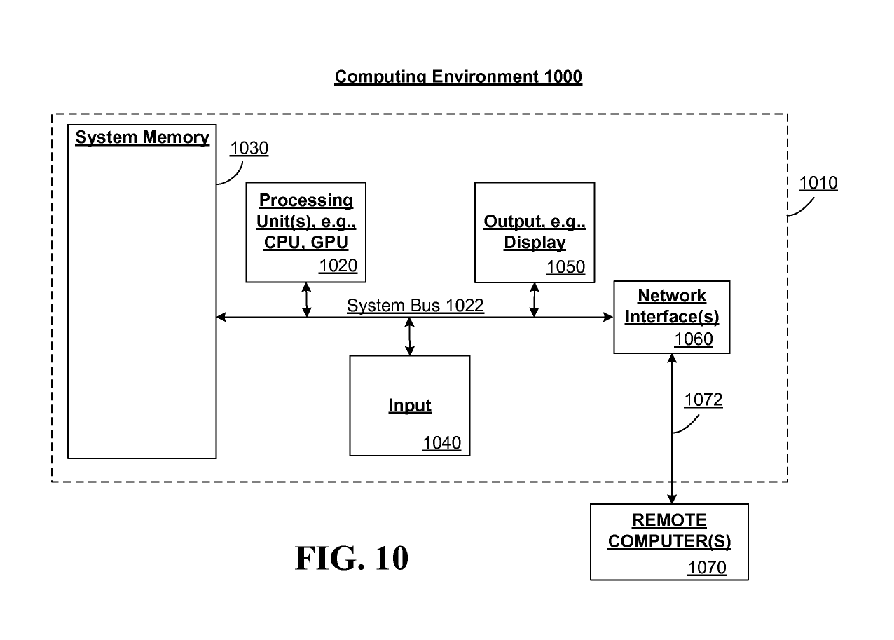

As mentioned, advantageously, the techniques described herein can be applied to any device where it is desirable to perform efficient querying. It is to be understood, therefore, that handheld, portable and other computing devices and computing objects of all kinds are contemplated for use in connection with the various embodiments, i.e., anywhere that a device may wish to read or write transactions from or to a data store. Accordingly, the below general purpose remote computer described below in FIG. 10 is but one example of a computing device. Additionally, a database server can include one or more aspects of the below general purpose computer, such as a media server or consuming device for the querying techniques, or other media management server components.

Although not requested, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 thus illustrates an example of a suitable computing system environment 1000 in which one or aspects of the embodiments described herein can be implemented, although as made clear above, the computing system environment 1000 is only one example of a suitable computing environment and is not intended to suggest any limitation as to scope of use or functionality. Neither is the computing environment 1000 be interpreted as having any dependency or requirement relating to any one or combination of components illustrated in the exemplary operating environment 1000.

With reference to FIG. 10, an exemplary remote device for implementing one or more embodiments includes a general purpose computing device in the form of a computer 1010. Components of computer 1010 may include, but are not limited to, a processing unit 1020, a system memory 1030, and a system bus 1022 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user can enter commands and information into the computer 1010 through input devices 1040. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the dynamic composition techniques. Thus, embodiments herein are contemplated from the standpoint of an API (or other software object), as well as from a software or hardware object that implements one or more aspects of the smooth streaming described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, illustrated blocks may be optional to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

What is claimed is:

1. A method, comprising:
receiving, by a computing device, a request for information based on data;
generating a query configured to determine the information;
performing the query to a first level of completion less than a pre-defined full completion; and
determining a first estimation of the information based on the performing the first level of completion.

2. The method of claim 1, wherein the query comprises a computation based on N number of related functions, where N is an integer, and wherein the performing the query to the first level of completion comprises:
determining an estimated output of a first function; and
employing the estimated output of the first function in the computation.

3. The method of claim 2, wherein N is an integer greater than one, further comprising:
performing the query to a second level of completion less than the pre-defined full completion, including determining an estimated output of a second function and employing the estimated output of the second function and the first function in the computation; and
determining a second estimation of the information based on the performing the query to the second level of completion.

4. The method of claim 1, wherein the query comprises a computation based on N number of related functions, N is an integer, and the performing the query to the first level of completion comprises:
performing N−M number of functions, wherein M is an integer and M<N.

5. The method of claim 4, further comprising:
performing the query to a second level of completion, including performing N−P number of functions, where P is an integer and M<P<N; and
determining a second estimation of the information based on the performing the query to the second level of completion.

6. The method of claim 1, wherein the query comprises a computation based on N number of related functions, where N is an integer, and wherein the performing the query to the first level of completion comprises:
determining a subset of the data; and
employing the subset of the data as input of at least one of the functions.

7. The method of claim 6, wherein the determining the subset of the data comprises determining an estimation of the subset of the data based on statistics associated with the data.

8. The method of claim 1, wherein the query comprises a computation based on N number of related functions, N is an integer greater than 1, and the performing the query to the first level of completion comprises:
performing the functions according to a priority order based on at least one of: a time associated with the data, a cost associated with performing the function, a degree of accuracy associated with the first estimation of the information, or an efficiency associated with the determining the first estimation of the information.

9. The method of claim 1, wherein the performing the query to the first level of completion comprises:
receiving a control function; and
performing the query based on the control function.

10. The method of claim 9, wherein performing the query based on the control function includes performing the query based on at least one of: a cost associated with performing the query, a resource constraint associated with performing the query, a duration of time associated with performing the query, a degree of accuracy associated with first estimation of the information, a confidence level associated with the first estimation of the information, or a speed associated with determining the first estimation of the information.

11. A system, comprising:
a memory having computer executable components stored thereon; and
a processor communicatively coupled to the memory, the processor configured to facilitate execution of the computer executable components, the computer executable components, comprising:
a search component configured to receive a request for first information based on data; and
a management component configured to determine a degree of accuracy requested for the first information, and wherein the search component is further configured to render the first information based on the degree of accuracy requested.

12. The system of claim 11, wherein the search component is further configured to generate a query configured to determine the first information, wherein the management component is configured to instruct the search component to perform the query to a level of completion less than a pre-defined full completion in response to the degree of accuracy requested being below a predetermined threshold, and wherein the search component is configured to render an estimation of the first information.

13. The system of claim 12, wherein the management component is configured to instruct the search component to perform the query to the level of completion less than the pre-defined full completion based on at least one of a duration of time associated with performing the query, a cost associated with performing the query, or a resource constraint associated with performing the query, and wherein the search component is configured to render an estimation of the first information.

14. The system of claim 12, wherein the query comprises a computation based on N number of related functions, N is an integer, and the management component is configured to instruct the search component to sample the data to determine an estimated input for at least one of the functions and to perform the query computation with the at least one estimated input.

15. The system of claim 12, where the management component is further configured to instruct the search component to perform the query to the pre-defined full completion in response to the degree of accuracy requested being above the predetermined threshold, and wherein the search component is configured to render the first information.

16. The system of claim 11, wherein the search component is further configured to receive multiple requests for additional information based on the data, and wherein the search component is configured to generate and perform queries to determine either the additional information or an estimation of the additional information, the system further comprising:
a tracking component configured to track query information associated with the queries.

17. The system of claim 16, further comprising
an analysis component configured to determine a correlation between the request for the first information and the query information, and wherein the search component is configured to employ the query information to determine the first information or an estimation of the first information based on the degree of accuracy requested for the first information.

18. A computer-readable storage medium comprising computer-readable instructions that, in response to execution, cause a computing system to perform operations, comprising:
receiving a request for information based on data;
generating a query configured to determine the information;
performing the query to a first level of completion less than the pre-defined full completion; and
determining a first estimation of the information based on the performing the query to the first level of completion.

19. The computer-readable storage medium of claim 18, wherein the query comprises a computation based on N number of related functions, N is an integer, and the performing the query to the first level of completion comprises:
determining an estimated output of a first function; and
employing the estimated output of the first function in the computation.

20. The computer-readable storage medium of claim, where N is an integer greater than one, further comprising operations for:
performing the query to a second level of completion, including determining an estimated output of a second function and employing the estimated output of the second function and the first function in the computation; and
determining a second estimation of the information based on the performing the query to the second level of completion.
